(19) United States
(12) Patent Application Publication
(10) Pub. No.: US 2012/0017393 A1
(43) Pub. Date: Jan. 26, 2012

(54) Self closing gate with concealed pivot point hinge

(76) Inventor: Joseph Pate, JR., Hamilition, OH (US)

(21) Appl. No.: 12/804,459

(22) Filed: Jul. 22, 2010

(51) Int. Cl. E05D 11/00

(52) U.S. Cl. 16/273

(57) ABSTRACT

A self closing hinge is placed within the tubular structure of the gate. The inventive hidden hinge swing pivot point cannot physically smash fingers. An internal axel physically holds together an upper hinge piece which receives the upper part of the gate, an upper hinge piece, and a midsection outer tubular section which contains an adjustable bushing and a spiral spring to return the gate to a closed position. The internal axel joins the lower hinge piece and the lower section which receives lower part of workpiece gate.

### BACKGROUND OF THE INVENTION

1. Field of the Invention

The invention is concerned with self closing gates. In particular the present invention is concerned with inventive hinges that prevent body harm to fingers by not having pinch points. It is especially concerned with safety control gates at various work places and amusement parks. Typically these gates have ordinary hinges, which hinges can harm fingers when closed carelessly. The present invention prevents body harm by using a hidden hinge which hinge swing pivot point cannot physically smash fingers.

2. Description of the Related Art

Self-closing gates are a common everyday art. Some gates have springs or other resilient means that urges the gate shut after its open. The present invention is concerned with gates which provide effective traffic control. The problem of particular concern addressed by the present invention is that safety control gates use hinges that can injure fingers especially of small children. Such injuries can lead to unpleasant lawsuits. The present invention addresses this problem by having a hidden hinge within the safety control gate, which hidden hinge cannot cause body harm. An important feature of the present invention is that it opens and swings on a level plane and swings open to 120 degrees and is self closing.

### SUMMARY OF INVENTION

The invention is a gate with self closing internal hinge. This hinge has a cylindrical upper hinge piece with an upper hollow core for an axel. A hole passes through the outer cylindrical surface of the upper hollow core. The base of this cylindrical upper hinge has an axel passage.

The invention further has a stationary hinge part with a resilient affixment means on its lower surface. The hinge to close the gate has a resilient means with an upper and lower attachment means. The internal hinge has an adjustable bushing through which is placed the axel. This adjustable bushing has a lower resilient affixment means on its upper surface and tension rotation adjustment holes. The adjustable bushing is housed in the lower part of mid section outer tubular section.

The inventive hinge has a lower passive stationary hinge part. The passive stationary hinge part has a central tunnel for the internal axel and has an upper and a lower friction reducing means. Likewise the inventive hinge has a cylindrical lower hinge piece with hollow core for internal axel and has a lower section to receive the workpiece gate. Passing through the invention is an internal axel with a first end with a flat plate and a second end. An affixment means on the second end holds the hinge together and provides a pivot point.

### BRIEF DESCRIPTION OF FIGURES

FIG. 1 shows workpiece control gate 301 with hidden hinge 100. FIG. 2 show the exploded hidden hinge 100 part and internal axel 101.

### DETAILED DESCRIPTION OF FIGURES

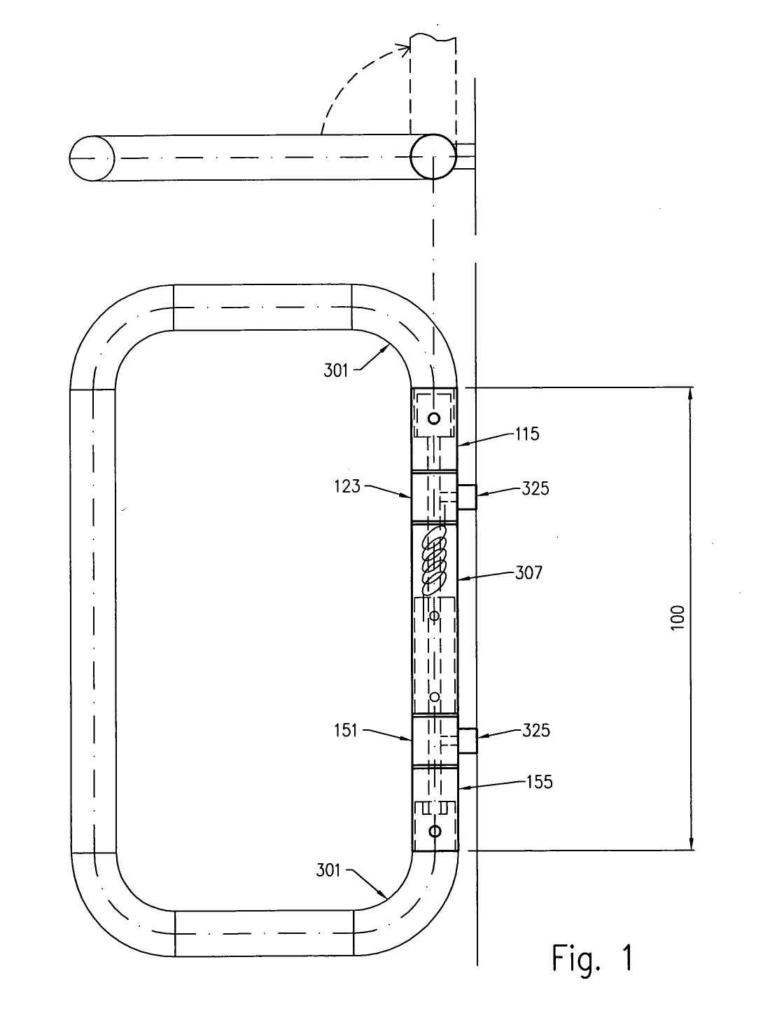

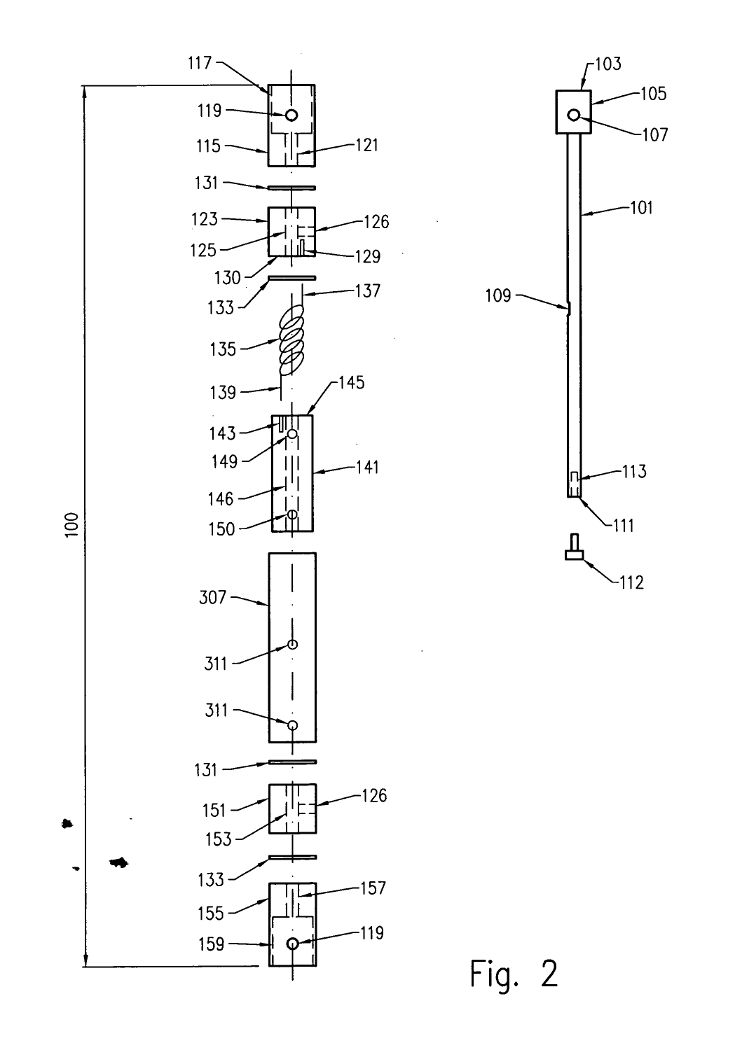

FIG. 1 shows tubular workpiece control gate 301 inventive hidden hinge 100. Hidden hinge 100 is attached to workpiece gate mount 325. A workpiece screw attaches penetration 126 of hinge part 123 to workpiece mount 325. A second workpiece screw attaches passive stationary hinge part 151 to mount 325.

FIG. 2 shows internal construction of the hidden hinge 100. Upper hinge piece 115 has upper hollow core 117. Affixment hole 119 passes into outer cylindrical surface of hinge piece 115. Passing through base of cylindrical upper hinge piece 115 is an axel passage 121. Between hinge piece 115 and stationary hinge part 123 is first upper friction reducing washer 131. Friction reducing washers are a friction reducing means, as are ball bearings.

Stationary hinge part 123 has central tunnel 125 for internal axel 101. Affixment penetration passage 126 attaches to a workpiece gate mount 325. Stationary hinge part 123 has an upper spring end inlet 129 on its lower surface 130. Upper spring inlet 129 on lower surface 130 is an affixment means for resilient means.

Mid section outer tubular section 307 is between lower friction reducing washer 133 and second upper friction reducing washer 131. Tubular section 307 hollow contains spiral spring 135 (resilient means). Spiral spring 135 has a first straight end 137 (upper attachment means) which is placed into upper spring end inlet 129. Second straight end 139 (lower attachment means) is placed into a lower spring inlet 143 on upper surface 145 of adjustable bushing 141 with axel passage 146 through which is placed said internal axel 101.

Adjustable bushing 141 which has axel passage 146 is placed in lower part of mid section outer tubular section 307. Adjustable bushing 141 is affixed within mid section of outer tubular section 307 by screws that pass through mid section outer tubular section 307 holes 311 and into depressions 149 and 150 of rotation adjustable bushing 141.

Stationary hinge part 151 with central tunnel for internal axel 101 is placed between upper friction reducing washer 131 and lower friction reducing washer 133. Affixment penetration 126 attaches stationary hinge part 151 to workpiece gate mount 325.

Cylindrical lower hinge piece 155 with has a central tunnel 157 for internal axel 101. Lower cylindrical hinge piece 155 has hollow lower section 159. Affixment hole 119 passes into outer cylindrical surface of hollow lower section 159. Hollow lower section 159 receives the workpiece gate 301.

Hidden hinge 100 is an integral part of gate 301.

FIG. 2 also shows internal axel 101. Internal axel has a first end 103 with a flat plate 105. Flat plate 105 has hole 107 drilled through its approximate center. A secant cut 109 is in the mid part of axel 101. Internal axel 101 has a second end 111 which has a tapped hole 113. Tapped hole 113 receives cap screw 112. Tapped hole 113 with cap screw 112 is an affixment means for internal axel 101.

As assembled, internal axel 101 first passes hinge piece 115 an axel passage 121, through washer 131 and central tunnel 125 of stationary hinge part 123. Axel 101 then passes through washer 133 on through spiral spring 135 and adjustable bushing 141. Spiral spring 135 and adjustable bushing 141 are housed within mid section outer tubular section 307. Axel 101 passes through washer 131 then passes though central tunnel 153 of stationary hinge part 151, though washer 133 and on through hollow core 157 of cylindrical lower hinge piece 155. Axel 101 terminates in hollow lower section 159 of lower cylindrical hinge piece 155. Internal axel 101 maintains inventive hinge 100 as a unit by turning cap screw 112 into tapped hole 113. The cap screw turning is completed within hollow lower section 159 of lower cylindrical hinge piece 155.

I claim:

1. A self closing gate with internal hinge comprising:
a) an internal axel [101];
said internal axel has a first end [103] with a flat plate [105];
said flat plate [105] has hole [107] drilled through its approximate center;
a secant cut [109] in the mid part of said axel;
a second end [111] with has a tapped hole [113];
said tapped hole [111] receives cap screw [112];
b) a cylindrical upper hinge piece [115];
said cylindrical upper hinge piece has an upper hollow core [117];
passing through outer cylindrical surface of said upper hollow core is an affixment hole [119];
passing through base of said cylindrical upper hinge piece is an axel passage [121];
said cylindrical upper hinge piece receives upper part of workpiece gate [301].
c) a stationary hinge part [123];
said stationary hinge part has a central tunnel [125] for said internal axel [101];
an affixment penetration [126] to attach to a workpiece gate mount [325];
said stationary hinge part has an upper spring end inlet [129] on its lower surface [130];
d) an upper friction reducing washer [131] placed above said hinge part [123];
e) a lower friction reducing washer [133] placed below said hinge part [133];
f) a resilient means;
said resilient means is a spiral spring [135];
said spiral spring has a first straight end [137] and a second straight end [139];
g) an adjustable bushing [141] through which is placed said internal axel [101];
said adjustable bushing has a lower spring inlet [143] on its upper surface [145] and tension rotation adjustment depressions [149,150];
said adjustable bushing is housed in the lower part of mid section outer tubular section [307];
h) a lower passive stationary hinge part [151];
said passive stationary hinge part [151] has a central tunnel [153] for said internal axel [101];
said lower passive stationary hinge part [151] is placed between upper friction reducing washer [131] and lower friction reducing washer [133];
i) a cylindrical lower hinge piece [155] with hollow core [157] for internal axel [101];
said cylindrical lower hinge piece [155] has hollow lower section [159] said lower section [159] receives lower part of workpiece gate [301];
when assembled said second end [111] of said internal axel [101] is inserted first through said axle passage [121] of said cylindrical upper hinge piece [115];
said flat plate [105] is held in place within upper hollow core [117];
on through said upper friction reducing washer [131];
and pass through said central tunnel [125] of stationary hinge part [123];
on through said lower friction reducing washer [133];
through said spiral spring [135];
said first straight end [137] of said spiral spring [135] is inserted into said upper spring end inlet [129] of stationary hinge part [123];
said second straight end [139] said spiral spring [135] this place into lower spring inlet [143] of said adjustable bushing [141];
said internal axel [101] passes through said adjustable bushing [141];
said spiral spring [135] and said adjustable bushing [141] are housed in said midsection outer tubular section [307];
said internal axel [101] further passes through said second upper friction reducing washer [131];
through said stationary hinge part [151];
after passing through said lower friction reducing washer [133] into said hollow core [157] of said cylindrical lower hinge piece [155];
said internal axel [101] holds said hidden hinge [100] as a unit by means of said cap screw [112] threaded into said tapped hole [113] within said hollow lower section [159] of cylindrical lower hinge piece [155];
said cylindrical lower hinge piece [155] is connected to said workpiece gate [301};
said stationary hinge part [123] is affixed to workpiece gate mount [325];
and said passive stationary hinge part [151] is also affixed to workpiece gate mount [325].

2. A gate with self closing internal hinge comprising:
a) an internal axel [101];
said internal axel has a first end [103] with a flat plate [105];
a second end [111];
an affixment means for said second end;
b) a cylindrical upper hinge piece [115];
said cylindrical upper hinge piece has an upper hollow core [117] for axel [101];
passing through outer cylindrical surface of said upper hollow core is an affixment hole [119];
base of said cylindrical upper hinge has axel passage [121];
c) a stationary hinge part [123];
said stationary hinge part has a central tunnel [125] for said internal axel [101];
an affixment penetration [126] to attach to a workpiece gate post;
said stationary hinge part has resilient affixment means on its lower surface [130];
d) a resilient means with an upper and lower attachment means;
e) an adjustable bushing [141] through which is placed said internal axel [101];
said adjustable bushing has a lower resilient affixment means on its upper surface [145] and tension rotation adjustment holes [149, 150];
said adjustable bushing is housed in the lower part of mid section outer tubular section [307];
f) a lower passive stationary hinge part [151];
said passive stationary hinge part [151] has a central tunnel [153] for said internal axel [101];
said lower passive stationary hinge part [151] is placed between its upper friction reducing means [131] and its lower friction reducing means [133];
g) a cylindrical lower hinge piece [155] with hollow core [157] for internal axel [101];
said lower section [159] receives lower part of workpiece gate [301].
